(19) United States
(12) Patent Application Publication
(10) Pub. No.: US 2016/0192055 A1
(43) Pub. Date: Jun. 30, 2016

(54) DRIVE-BY-WIRE EARPHONE CAPABLE OF BEING CONNECTED WITH INPUT SOURCE FOR WIRELESS COMMUNICATION

(71) Applicant: Zhongshan K-mate General Electronics Co., Ltd., Zhongshan City (CN)

(72) Inventors: Decai Liu, Zhongshan City (CN); Xing Xu, Zhongshan City (CN); Ziqiang Yao, Zhongshan City (CN)

(21) Appl. No.: 14/818,354

(22) Filed: Aug. 5, 2015

(30) Foreign Application Priority Data
Dec. 26, 2014 (CN) 201410836778.6

(51) Int. Cl. H04R 1/10

(52) U.S. Cl. CPC H04R 1/1041; H04R 1/1025; H04R 2420/07

(57) ABSTRACT

A drive-by-wire earphone may be capable of being connected with an input source for wireless communication. A controller may be connected with a left earphone and a right earphone, and the left earphone and the right earphone may be respectively provided with a battery. Since batteries that can supply power to the controller are respectively arranged in the left earphone and the right earphone, a battery does not need to be built in the controller, and the volume of the controller can be reduced so that the volume of the drive-by-wire earphone is also reduced. Moreover, power may be continuously supplied to the controller for a longer time through the two batteries in the left earphone and the right earphone. As such, the drive-by-wire earphone may operate for a longer period of time.

### CROSS REFERENCE TO RELATED APPLICATION

This application claims the benefit of Chinese Utility Model Application No. 201410836778.6, filed Dec. 26, 2014. The subject matter of this earlier filed patent application is hereby incorporated by reference in its entirety.

### FIELD

The present invention generally relates to earphones, and more particularly, to a drive-by-wire earphone capable of being connected with external input source for wireless communication.

### BACKGROUND

It is known that a drive-by-wire earphone capable of being connected with an input source for wireless communication generally cannot work normally without a built-in power supply, typically a battery. Most drive-by-wire earphones capable of being connected with an input source for wireless communication on the market have a power supply battery arranged on the controller that increases the size and volume of the controller. Thus, the volume of this type of drive-by-wire earphone must be large enough to accommodate the battery. As such, conventional drive-by-wire earphones cannot be manufactured to as small of a size as may be desired.

In addition, since the power supply battery is arranged on the controller, in order to reduce the volume, conventional drive-by-wire earphones usually use a small or mini-type power supply battery. The power storage capacity of the power supply battery is not large, and as such, it cannot continuously supply power to the controller for a long period of time. Accordingly, an improved drive-by-wire earphone may be beneficial.

### SUMMARY

Certain embodiments of the present invention may provide solutions to the problems and needs in the art that have not yet been fully identified, appreciated, or solved by current drive-by-wire earphones. For example, some embodiments of the present invention provide a drive-by-wire earphone that has a relatively simple structure and a relatively small volume. In some embodiments, the drive-by-wire earphone not only can be connected with external input source for wireless communication, but also can work for a relatively long period of time.

The drive-by-wire earphone may be capable of being connected with an input source for wireless communication, and may include a controller. The controller may be connected with a left earphone and a right earphone. The left earphone and the right earphone may respectively be provided with a speaker for providing audio and a battery for supplying power to the controller.

The controller may include a master control panel, and a master control processor for processing various data and instructions may be arranged on the master control panel. The master control processor may be connected with a wireless transceiver to be connected with an external input source for wireless communication, memory for storing data, a control switch for inputting operation instructions, a microphone for receiving and inputting sound signals, a crystal oscillator, an audio processor for processing audio signals, and an indicator light indicating the working state of the controller.

The control switch may include more than one touch switch arranged on the master control panel. Two or three touch switches may be provided in some embodiments. The control switch may include one toggle switch and more than one touch switch. Both the toggle switch and the touch switches may be arranged on the master control panel. The control switch may include one toggle switch and two touch switches in some embodiments.

The drive-by-wire earphone may be provided with a microphone arranged on the controller, the left earphone, or the right earphone. The drive-by-wire earphone may be provided with two microphones in some embodiments. The two microphones may be respectively arranged on the left earphone and the right earphone, on the left earphone and the controller, or on the right earphone and the controller in certain embodiments.

Further, the drive-by-wire earphone may be provided with three microphones respectively arranged on the controller, the left earphone, and the right earphone in some embodiments. The drive-by-wire earphone may further include an NFC (Near Field Communication) communication module connected with the master control processor. The NFC communication module may be arranged on the left earphone, the controller, or the right earphone. The master control panel may be provided with a charging connector to be connected with an external input power source in some embodiments.

Since the batteries that can supply power to the controller are respectively arranged in the left earphone and the right earphone according to some embodiments of the present invention, a battery does not need to be built into the controller. Therefore, the volume of the controller, and of the drive-by-wire earphone itself, can be reduced over that of conventional earphones. Moreover, power may be continuously supplied to the controller for a longer period of time through the two batteries in the left earphone and the right earphone, and the continuous working time of the drive-by-wire earphone according to some embodiments of the present invention can be longer than that of conventional earphones.

In an embodiment, a drive-by-wire earphone capable of being connected with an input source for wireless communication includes a left earphone, a right earphone, and a controller. The controller is respectively connected with the left earphone and the right earphone through an electrical conductor. The left earphone and the right earphone respectively include a speaker to produce sound and a battery to supply power to the controller. The controller includes a master control panel, and a master control processor that processes data and instructions is arranged on the master control panel. The master control processor is connected with a wireless transceiver configured to be connected with an external input source for wireless communication, memory that stores data, a control switch that inputs operation instructions, a microphone that inputs sound signals, a crystal oscillator, an audio processor that processes audio signals, and an indicator light that indicates a working state of the controller.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a functional block diagram of a drive-by-wire earphone when employing one touch switch as a control switch, and only employing one microphone and one NFC communication module arranged on a controller, according to an embodiment of the present invention;

FIG. 2 is a functional block diagram of the control switch when employing two touch switches, according to an embodiment of the present invention;

FIG. 3 is a functional block diagram of the control switch when employing three touch switches, according to an embodiment of the present invention;

FIG. 4 is a functional block diagram of the control switch when employing one touch switch and one toggle switch, according to an embodiment of the present invention;

FIG. 5 is a functional block diagram of the control switch when employing two touch switches and one toggle switch, according to an embodiment of the present invention;

FIG. 6 is a functional block diagram of the control switch when employing a microphone arranged on the left earphone, according to an embodiment of the present invention;

FIG. 7 is a functional block diagram of the control switch when employing a microphone arranged on the right earphone, according to an embodiment of the present invention;

FIG. 8 is a functional block diagram of the control switch when employing a microphone on both the left and right earphone, according to an embodiment of the present invention.

FIG. 9 is a functional block diagram of the control switch when employing a microphone on both the left earphone and the controller, according to an embodiment of the present invention.

FIG. 10 is a functional block diagram of the control switch when employing a microphone on both the right earphone and the controller, according to an embodiment of the present invention.

FIG. 11 is a functional block diagram of the control switch when employing a microphone on the left earphone, the right earphone, and the controller, according to an embodiment of the present invention.

FIG. 12 is a functional block diagram of the control switch when the NFC communication module is arranged on the left earphone, according to an embodiment of the present invention;

FIG. 13 is a functional block diagram of the control switch when the NFC communication module is arranged on the right earphone, according to an embodiment of the present invention;

FIG. 14 is an outside structure schematic view of the drive-by-wire earphone, according to an embodiment of the present invention; and

FIG. 15 is a state block diagram of when the drive-by-wire earphone is used by a user and connected with an external input source for wireless communication, according to an embodiment of the present invention.

### DETAILED DESCRIPTION OF THE EMBODIMENTS

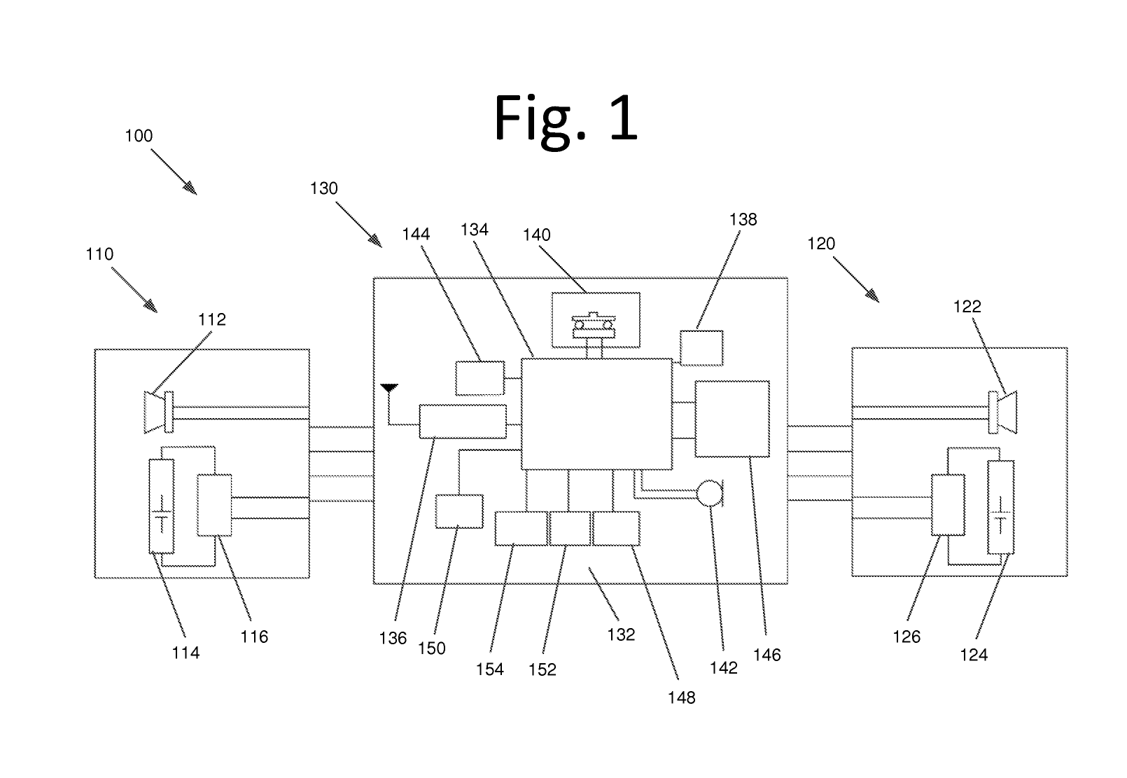

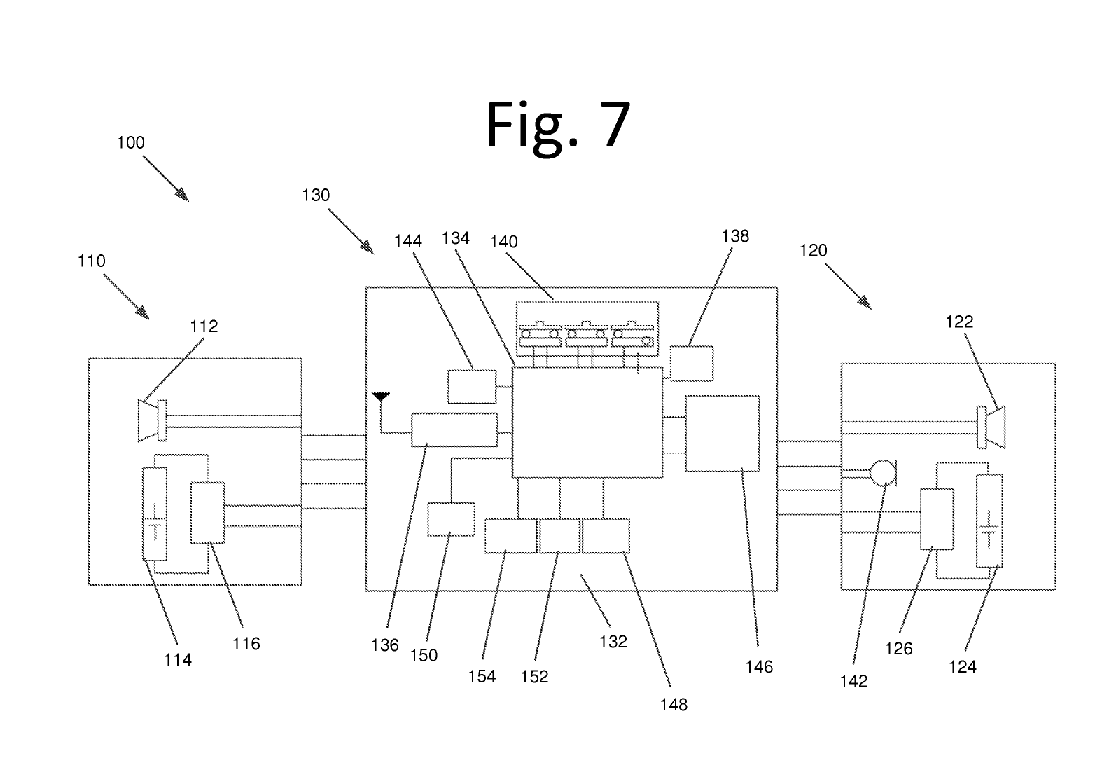

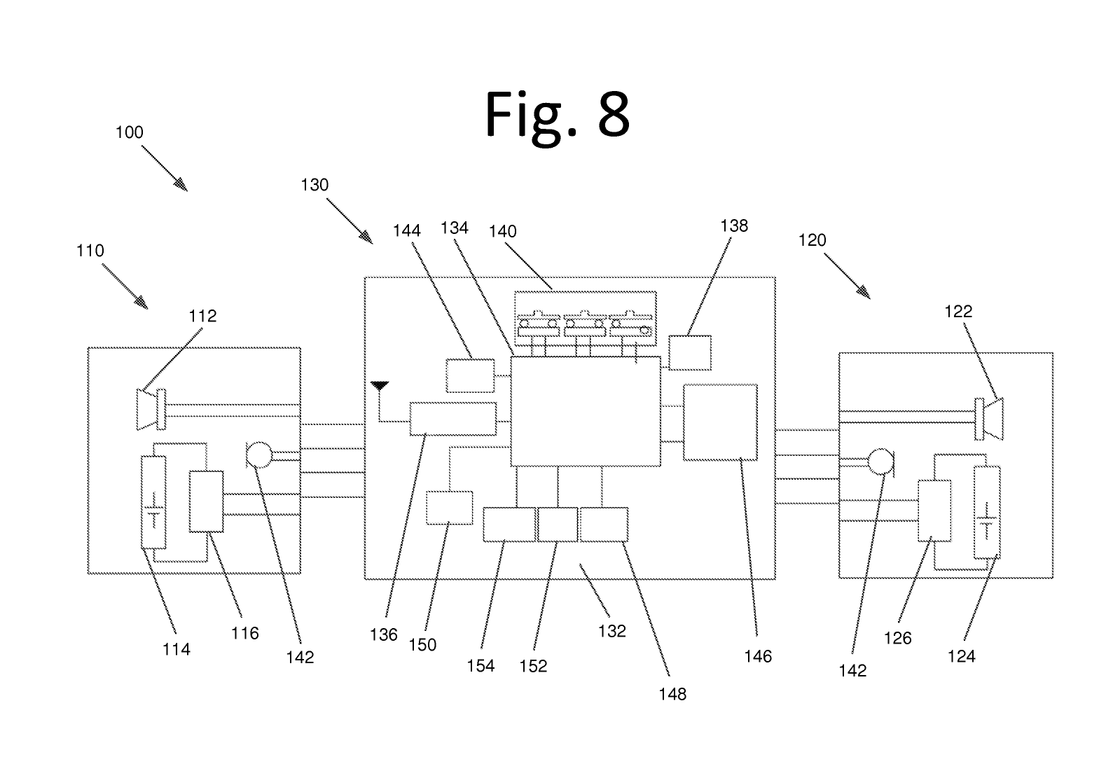

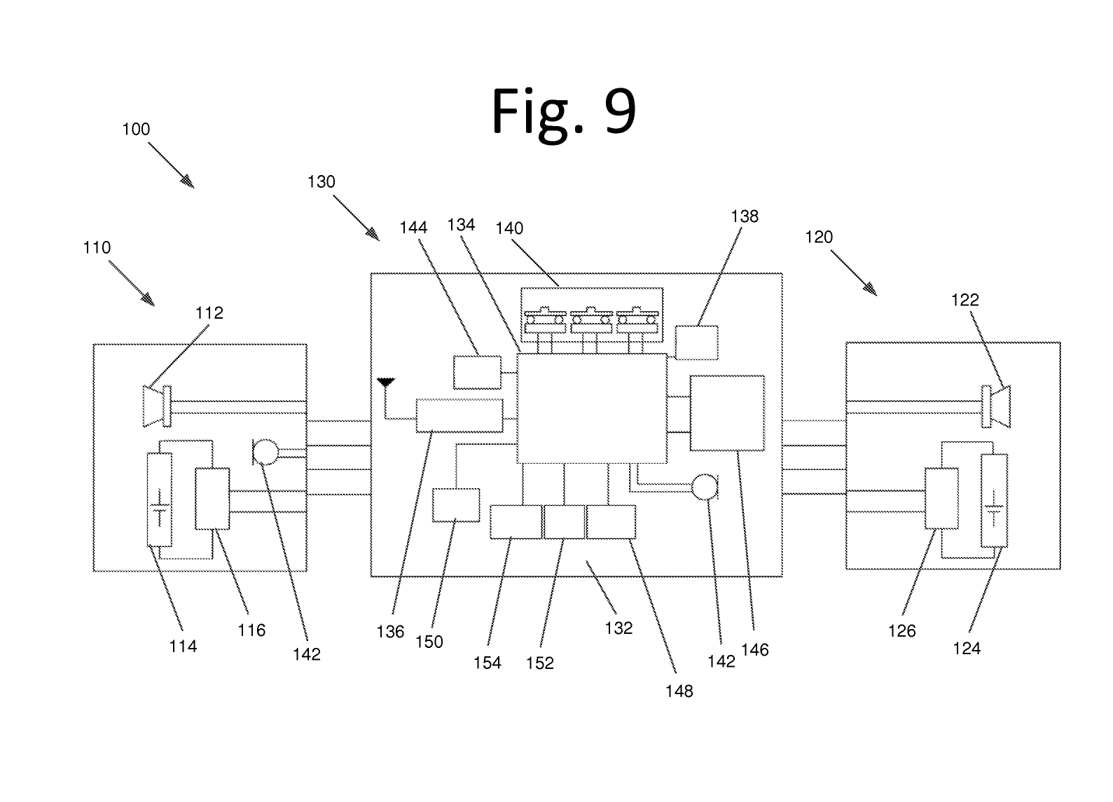

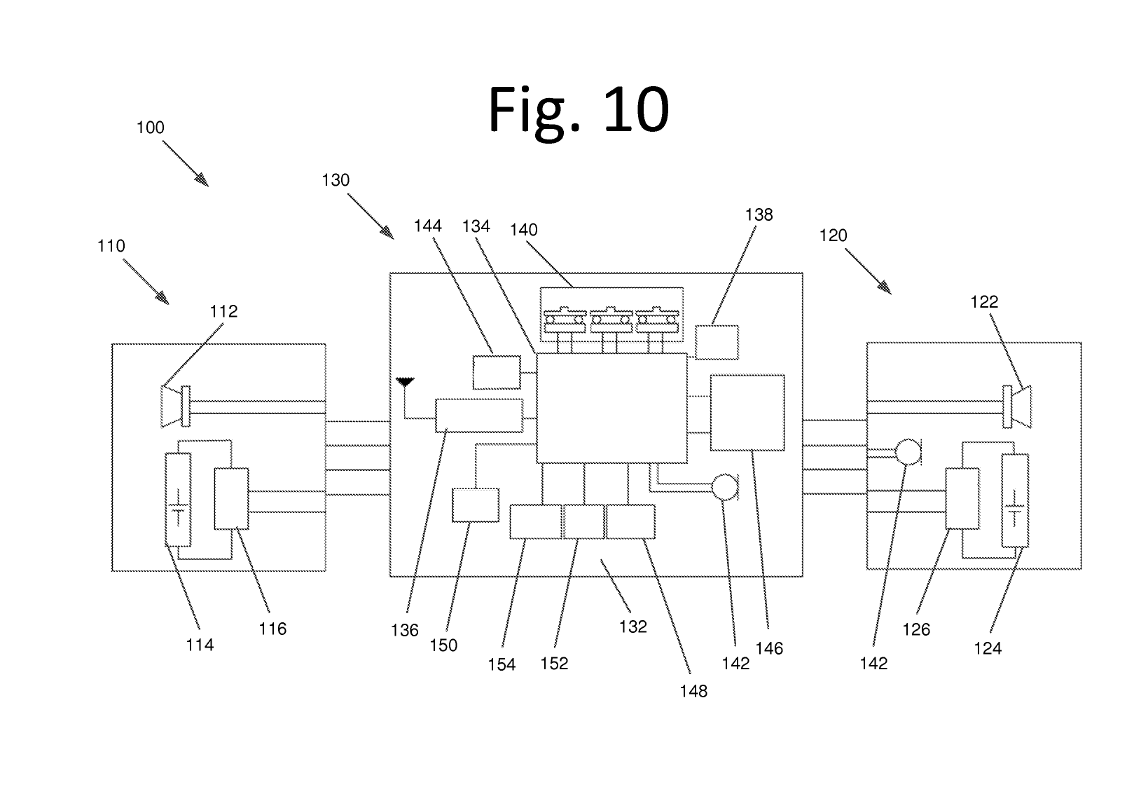

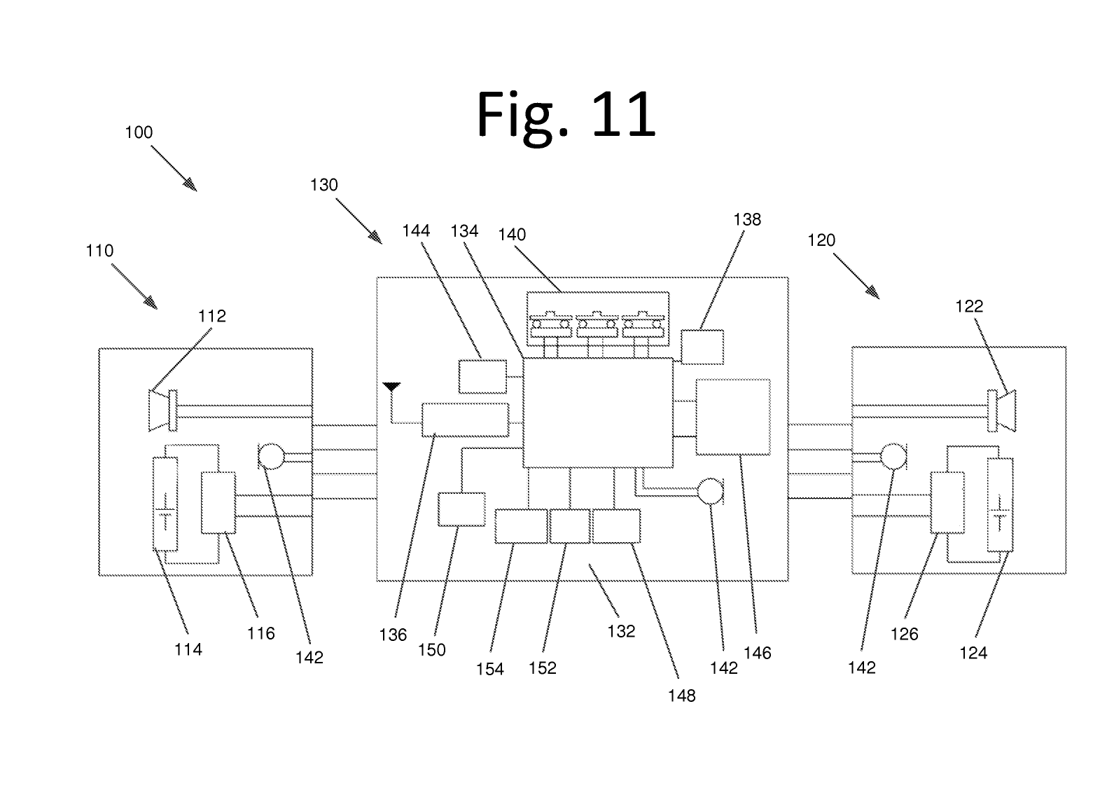

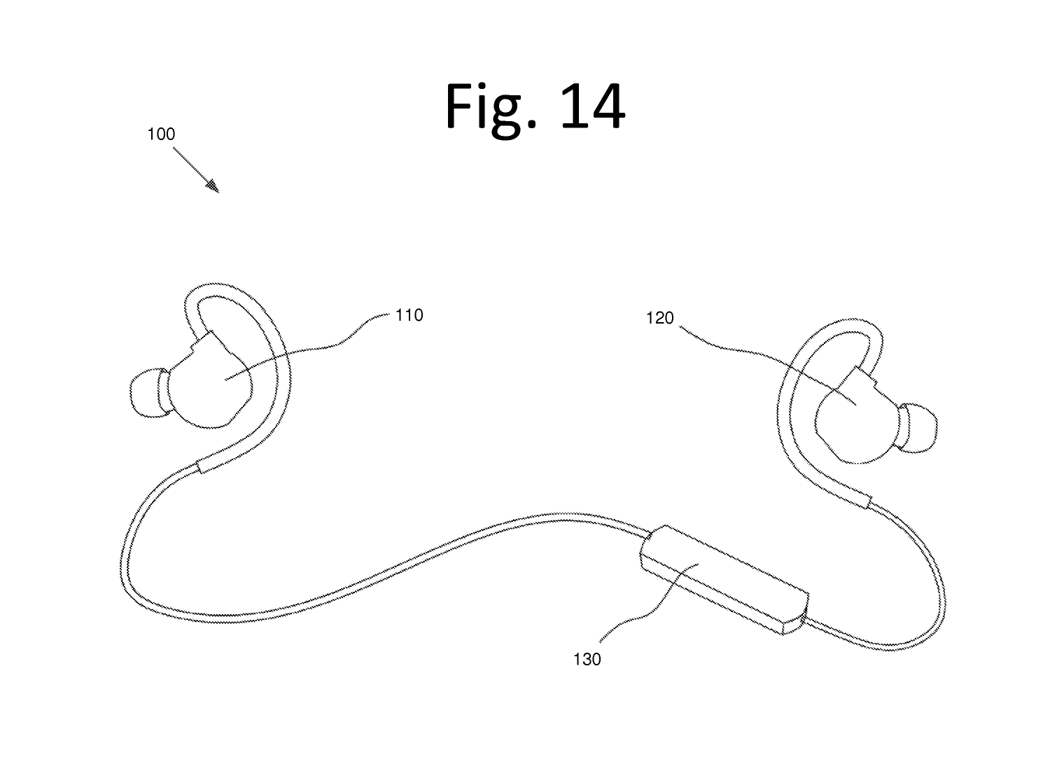

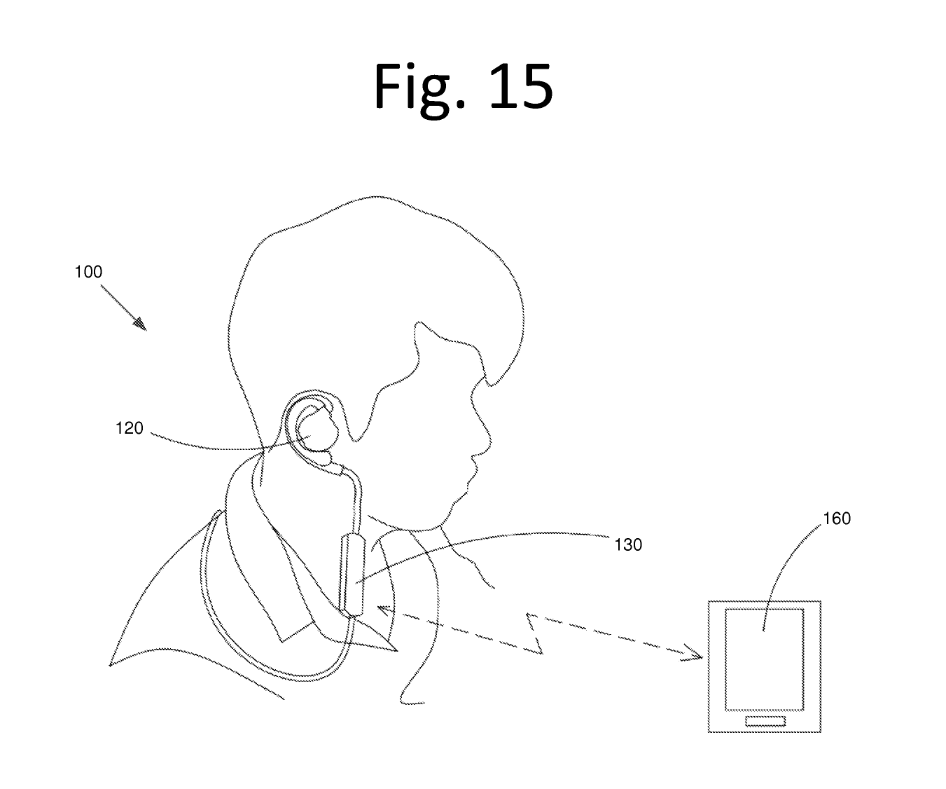

Referring to FIG. 1 to FIG. 15, a drive-by-wire earphone capable of being connected with an input source for wireless communication 100 includes a controller 130. Controller 130 is respectively connected with a left earphone 110 and a right earphone 120 through an electrical conductor (e.g., wire). Left earphone 110 and right earphone 120 are respectively provided with speakers 112, 122 for providing audio and batteries 114, 124 for supplying power to controller 130. In this embodiment, for better managing the quantity of electricity from batteries 114, 124, left earphone 110 and right earphone 120 are respectively provided with a battery manager 116, 126 for managing batteries 114, 124. Battery managers 116, 126 are similarly connected with controller 130 through an electrical conductor. Controller 130 includes a master control panel 132, and a master control processor 134 for processing various data and instructions is arranged on master control panel 132. Master control processor 134 is connected with a wireless transceiver 136 to be connected with an external input source 160 for wireless communication (e.g., a cell phone—see FIG. 15), memory 138 for storing data, a control switch 140 for inputting operation instructions (shown as a single touch switch here), a microphone 142 for inputting sound signals, a crystal oscillator 144, an audio processor 146 for processing audio signals, and an indicator light 148 for indicating the working state of controller 130. In FIG. 1, to enable controller 130 to control the quantity of electricity of batteries 114, 124 in left earphone 110 and in right earphone 120, respectively, master control panel 132 is also provided with a power source manager 150 for controlling battery managers 116, 126 in left earphone 110 and in right earphone 120. Power source manager 150 is connected with master control processor 134. Accordingly, battery managers 116, 126 in left earphone 110 and in right earphone 120 are similarly connected with master control processor 134.

Since batteries 114, 124 that can supply power to controller 130 are respectively arranged in left earphone 110 and right earphone 120 according to this embodiment of the present invention, a battery does not need to be built into controller 130. Therefore, the physical volume of controller 130 can be reduced, thereby reducing the volume of drive-by-wire earphone 100. This smaller size may make drive-by-wire earphone 100 more desirable to consumers due to its more compact size. Moreover, batteries 114, 124 in left earphone 110 and in right earphone 120, respectively, can continuously supply power to controller 130 for a longer period of time. Therefore, the continuous working time of drive-by-wire earphone 100 according to this embodiment of the present invention is longer, and the user does not need to charge drive-by-wire earphone 100 as frequently. This provides a better usage experience for the user.

Referring to FIG. 1, drive-by-wire earphone 100 according to this embodiment of the present invention employs one touch switch as control switch 140 for inputting operation instructions, and the touch switch is arranged on master control panel 132. Drive-by-wire earphone 100 also employs only one microphone 142 and one NFC communication module 152 in this embodiment. Microphone 142 and NFC communication module 152 are both arranged on master control panel 132, i.e., microphone 142 and NFC communication module 152 are both arranged on controller 130. When the user wishes to input an operation instruction into controller 130, the user may input various operation instructions. For example, the user may input an instruction of starting or stopping the operation of controller 130, or input instructions such as fast forward, rewind, play, pause, last song, next song, or the like through the amount of time that the user presses control switch 140 (e.g., a touch switch), or touching control switch 140 for different times within a predetermined time period.

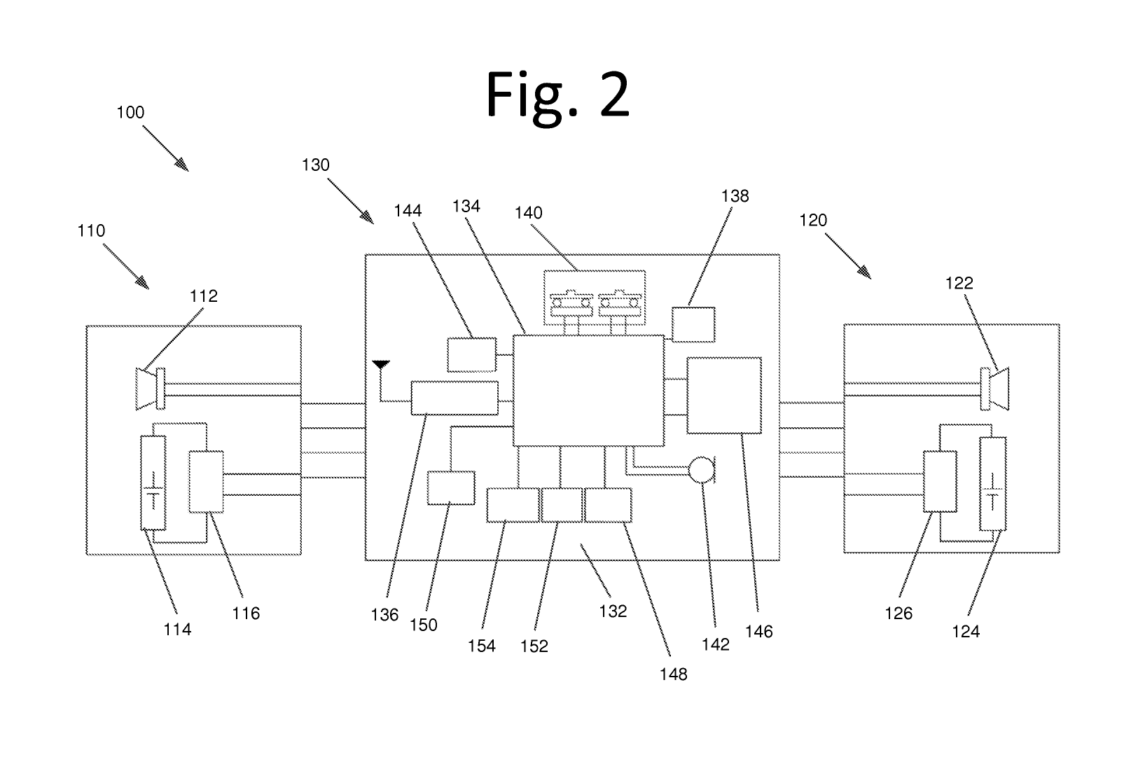

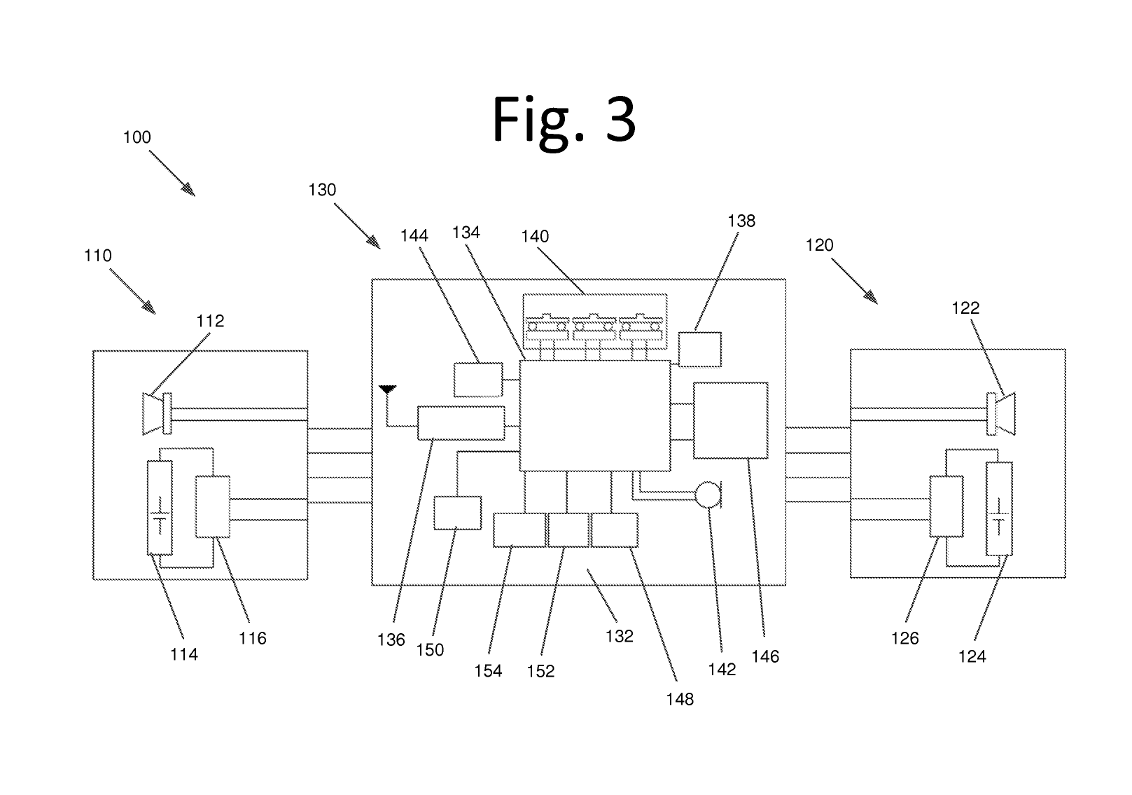

Referring to FIG. 2 and FIG. 3, drive-by-wire earphone 100 may also employ two touch switches or three touch switches, respectively, in control switch 140 for inputting operation instructions. The specific control modes for inputting different instructions may be set as desired according to use requirements.

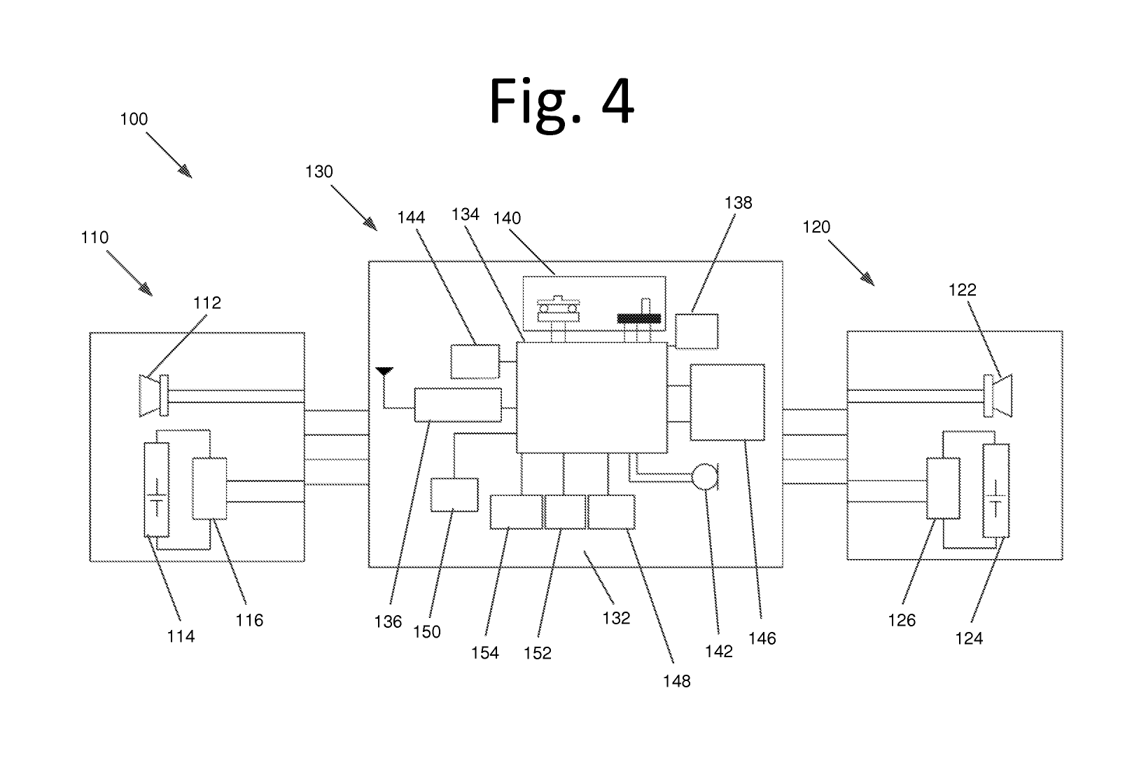

Referring to FIG. 4, drive-by-wire earphone 100 may also employ one toggle switch and one touch switch in control switch 140 for inputting operation instructions. Both the toggle switch and the touch switch are arranged on master control panel 132. In some embodiments, the toggle switch may be configured to control whether to provide electricity to controller 130, while the touch switch may input different control instructions, for example, input instructions including, but not limited to, answering calls, ending talking, play music, pause, last song, next song, and the like.

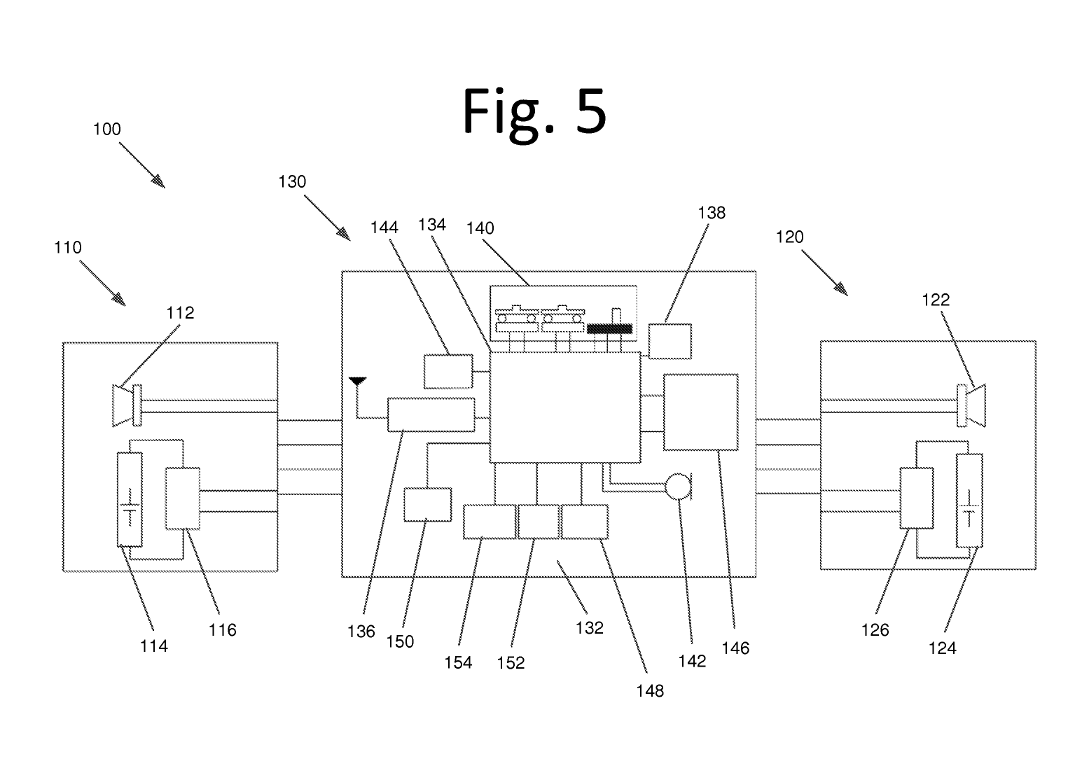

Referring to FIG. 5, drive-by-wire earphone 100 may also employ one toggle switch and two touch switches in control switch 140 for inputting operation instructions. The toggle switch may be configured to control whether to provide electricity to controller 130, while the two touch switches may input different control instructions, for example, input instructions including, but not limited to, answering calls, ending talking, play music, pause, last song, next song, and the like.

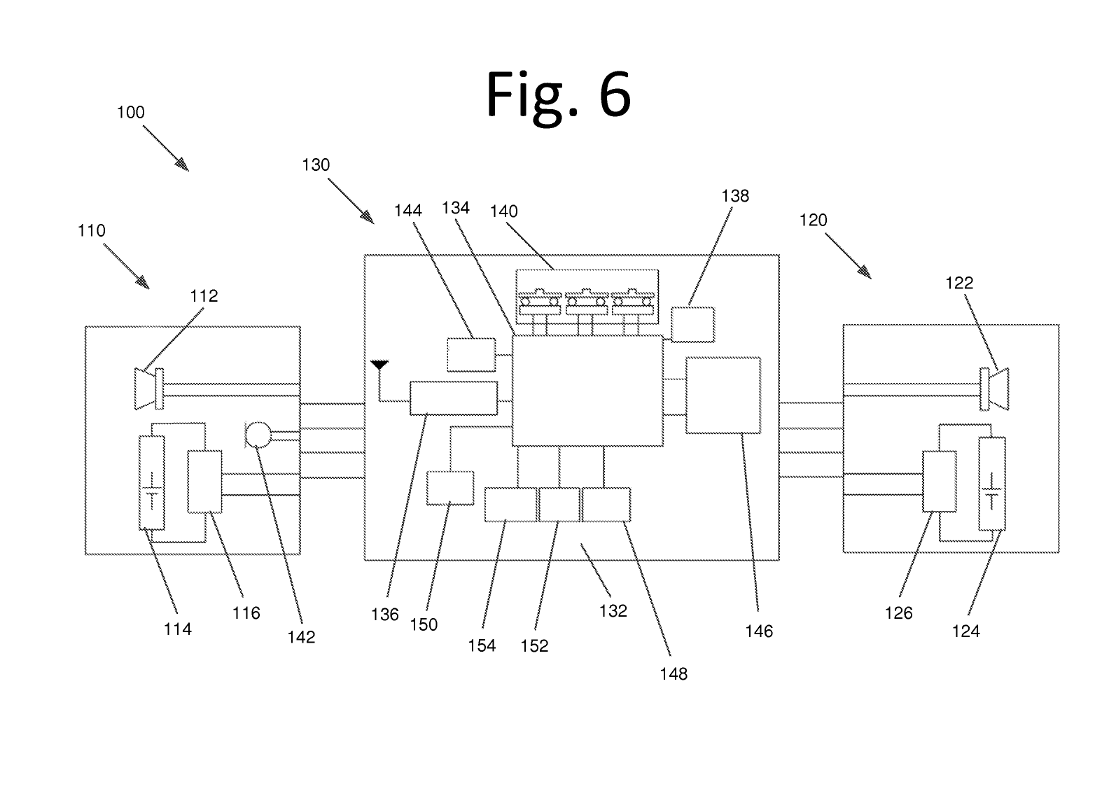

Referring to FIGS. 6-11, drive-by-wire earphone 100 may employ microphone 142 on left earphone 110, right earphone 120, controller 130, or any combination thereof. Through arranging microphone 142 on left earphone 110 and/or right earphone 120, voice can be better received by microphone 142 and transmitted to master control processor 134 for processing when the user or others are talking.

In some embodiments, only left earphone 110 or right earphone 120 may include a microphone. In other embodiments, multiple microphones may be included in left earphone 110, right earphone 120, controller 130, or any combination thereof. For instance, in certain embodiments, left earphone 110 and right earphone 120 may have a microphone, left earphone 110 and controller 130 may have a microphone, right earphone 120 and controller 130 may have a microphone, each of left earphone 110, right earphone 120, and controller 130 may have a microphone, etc. By using two microphones on different components of drive-by-wire earphone 100 (e.g., one on left earphone 110 and one on right earphone 120), the sound signals inputted by the user may be better received and the influences of noises from the surrounding environment on the sound signals inputted by the user can be effectively reduced. Through arranging three or more microphones on different components of drive-by-wire earphone 100 (e.g., one on left earphone 110, one on right earphone 120, and one on controller 130), the capacity of drive-by-wire earphone 100 for receiving the sound signals inputted by the user can be further enhanced, and the influences of the noises of the surrounding environment on the sound signals inputted by the user can be effectively reduced.

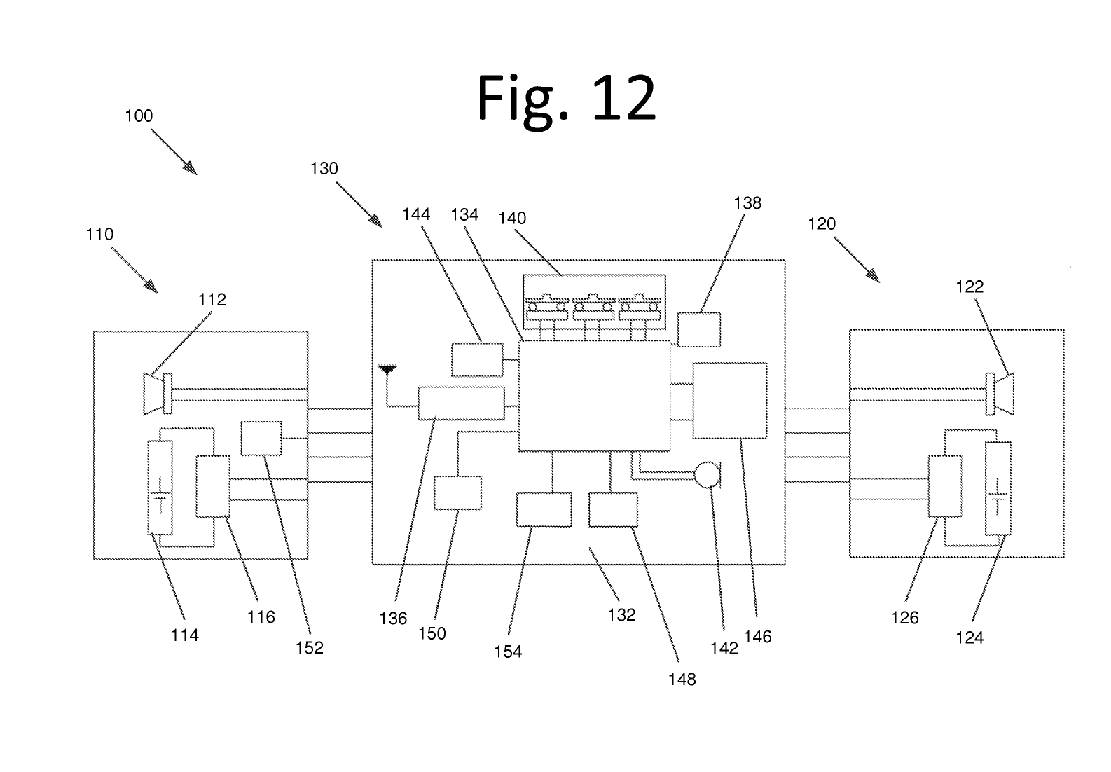

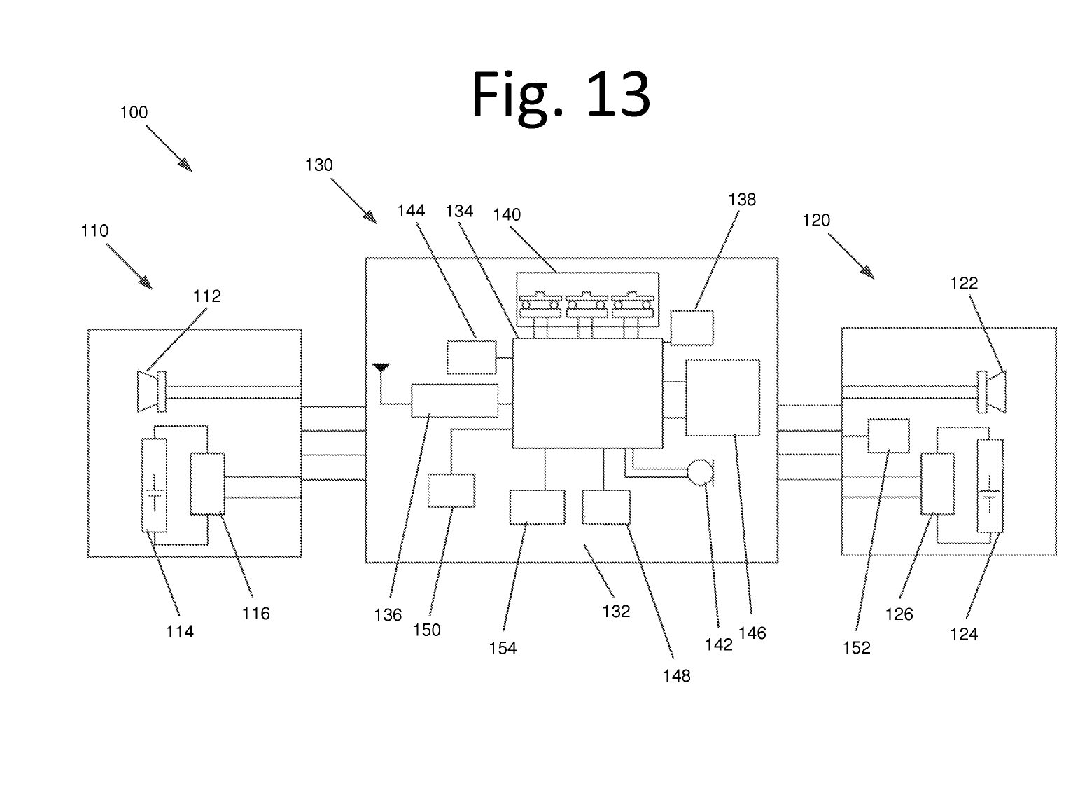

Referring to FIG. 12 and FIG. 13, NFC communication module 152 of drive-by-wire earphone 100 is included in left earphone 110 or right earphone 120, respectively. NFC communication module 152 is connected with master control processor 134. Through employing NFC communication module 152 on an earphone, drive-by-wire earphone 100 can conduct signal transmission with an external input source more quickly, which may omit certain tedious security verification steps, so as to make drive-by-wire earphone 100 more convenient to use.

Referring to FIGS. 1-13, in order to charge batteries 114, 124 in drive-by-wire earphone 100, master control panel 132 is also provided with a charging connector 154 to be connected with an external input power source (not shown). After connecting with charging connector 154, the external input power source can charge batteries 114, 124. After charging, batteries 114, 124 can continuously supply power to controller 130.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A drive-by-wire earphone capable of being connected with an input source for wireless communication, comprising:
a left earphone;
a right earphone; and
a controller, the controller respectively connected with the left earphone and the right earphone through an electrical conductor, wherein
the left earphone and the right earphone respectively comprise a speaker to produce sound and a battery to supply power to the controller,
the controller comprises a master control panel, and a master control processor that processes data and instructions is arranged on the master control panel, and
the master control processor is connected with a wireless transceiver configured to be connected with an external input source for wireless communication, memory that stores data, a control switch that inputs operation instructions, a microphone that inputs sound signals, a crystal oscillator, an audio processor that processes audio signals, and an indicator light that indicates a working state of the controller.

2. The drive-by-wire earphone according to claim 1, wherein the control switch comprises a plurality of touch switches, the plurality of touch switches arranged on the master control panel.

3. The drive-by-wire earphone according to claim 2, wherein two or three touch switches are included.

4. The drive-by-wire earphone according to claim 1, wherein
the control switch comprises one toggle switch and a plurality of touch switches, and
both the toggle switch and the plurality of touch switches are arranged on the master control panel.

5. The drive-by-wire earphone according to claim 4, wherein the control switch comprises one toggle switch and two touch switches.

6. The drive-by-wire earphone according to claim 1, wherein the drive-by-wire earphone further comprises a microphone, the microphone arranged on the controller, the left earphone, or the right earphone.

7. The drive-by-wire earphone according to claim 1, wherein the drive-by-wire earphone comprises two microphones, the two microphones respectively arranged on the left earphone and the right earphone, on the left earphone and the controller, or on the right earphone and the controller.

8. The drive-by-wire earphone according to claim 1, wherein the drive-by-wire earphone comprises three microphones respectively arranged on the controller, the left earphone, and the right earphone.

9. The drive-by-wire earphone according to claim 1, further comprising:
an NFC communication module connected with the master control processor, the NFC communication module arranged on the left earphone, the controller, or the right earphone.

10. The drive-by-wire earphone according to claim 1, wherein the master control panel further comprises a charging connector configured to be connected with an external input power source.
